(19) United States
(12) Patent Application Publication
(10) Pub. No.: US 2022/0069422 A1
(43) Pub. Date: Mar. 3, 2022

(54) CAST-IN-PLACE BUSBARS FOR BATTERY PACK

(71) Applicant: Apple Inc., Cupertino, CA (US)

(72) Inventors: Russell A. McLELLAN, Kamloops (CA); Steven KAYE, Oakland, CA (US)

(21) Appl. No.: 17/460,864

(22) Filed: Aug. 30, 2021

Related U.S. Application Data
(60) Provisional application No. 63/072,448, filed on Aug. 31, 2020.

(51) Int. Cl. H01M 50/505; H01M 50/534; H01M 4/04

(52) U.S. Cl. CPC H01M 50/505; H01M 4/0433; H01M 50/534

(57) ABSTRACT

The disclosed technology relates to a battery that utilizes a casted-in-place busbar to connect tabs of a battery cell with tabs of an adjacent cell. The busbar includes a first conductive material that is in direct contact with the tabs. The first conductive material is different from at least one of a material of the cathode tabs and a material of the anode tabs.

This patent application claims the benefit under 35 U.S.C. § 119(e) of U.S. Patent Application No. 63/072,448 entitled “Cast-in-Place Busbars for Battery Pack” and filed on Aug. 31, 2020, which is incorporated herein by reference in its entirety.

### TECHNICAL FIELD

The disclosure relates generally to a battery pack, and more particularly, to casted-in-place busbars for a battery pack.

### BACKGROUND

Battery packs comprise a plurality of battery cells and are used to provide power to a wide variety of devices. A battery cell may utilize a type of battery chemistry, such as lithium-ion or lead acid, to provide power to devices. It is common for battery chemistry to require different materials for substrates and/or tabs of a cathode and anode. For example, for a lithium-ion battery cell, aluminum may be used as the tab for the cathode and copper may be used as the tab of the anode. Certain battery cells may be made of an anode layer and a cathode layer, with a separator disposed there-between. The layers may be stacked or wound in a corresponding compartment of an enclosure. A conductive tab may be coupled to each cathode layer and a conductive tab may be coupled to each anode layer. The conductive tabs may be interconnected, connected to adjacent cells, and/or connected to terminals for the battery. The battery may include a battery management circuit module that is configured to manage discharging, recharging, and cell balancing of the battery pack.

### SUMMARY

The disclosed embodiments provide for a battery that utilizes a casted-in-place busbar to connect tabs of a battery cell with tabs of an adjacent cell. The battery includes a first set of electrodes including a plurality of cathode layers and a plurality of anode layers. Each cathode layer includes a cathode tab extending therefrom, and each anode layer includes an anode tab extending therefrom. The battery further includes a busbar that includes a first conductive material in direct contact with at least one of the cathode tabs and the anode tabs. The first conductive material is different from at least one of a material of the cathode tabs and a material of the anode tabs.

In some embodiments, a method for connecting a plurality of tabs of a set of electrodes is disclosed. The method includes arranging at least one of a plurality of cathode tabs extending from a plurality of cathode layers of a first set of electrodes and a plurality of anode tabs extending from a plurality of anode layers of the first set of electrodes into a cavity of a mold; and pouring a first conductive material within the cavity. The first conductive material comes in direct contact with at least one of the plurality of cathode tabs and the plurality of anode tabs. The method further includes casting a busbar formed of the first conductive material. The first conductive material is different from at least one of a material of the cathode tabs and a material of the anode tabs.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a perspective view of a battery with a casted-in-place busbar, in accordance with various embodiments of the subject technology;

FIG. 2 illustrates a perspective view of a mold used to create a cast-in-place busbar, in accordance with various embodiments of the subject technology;

FIG. 3A illustrates a perspective view of a mold and inserts used to create a cast-in-place busbar, in accordance with various embodiments of the subject technology;

FIG. 3B illustrates a section view of a mold and inserts used to create a cast-in-place busbar, in accordance with various embodiments of the subject technology;

FIG. 4A illustrates a perspective view of a battery pack inserted within a mold used to create a cast-in-place busbar, in accordance with various embodiments of the subject technology;

FIG. 4B illustrates a section view of a battery pack inserted within a mold used to create a cast-in-place busbar, in accordance with various embodiments of the subject technology;

FIG. 5 illustrates a section view of a battery pack inserted within a mold and molten material to form a cast-in-place busbar, in accordance with various embodiments of the subject technology;

FIG. 6A illustrates an alternative section view of a battery pack inserted within a mold and molten material to form a cast-in-place busbar, in accordance with various embodiments of the subject technology;

FIG. 6B illustrates a battery with casted-in-place busbars, in accordance with various embodiments of the subject technology;

FIG. 7 illustrates an example method for connecting a plurality of tabs of a set of electrodes, in accordance with various embodiments of the subject technology;

FIG. 8 illustrates an example method for connecting a plurality of tabs of a set of electrodes, in accordance with various embodiments of the subject technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

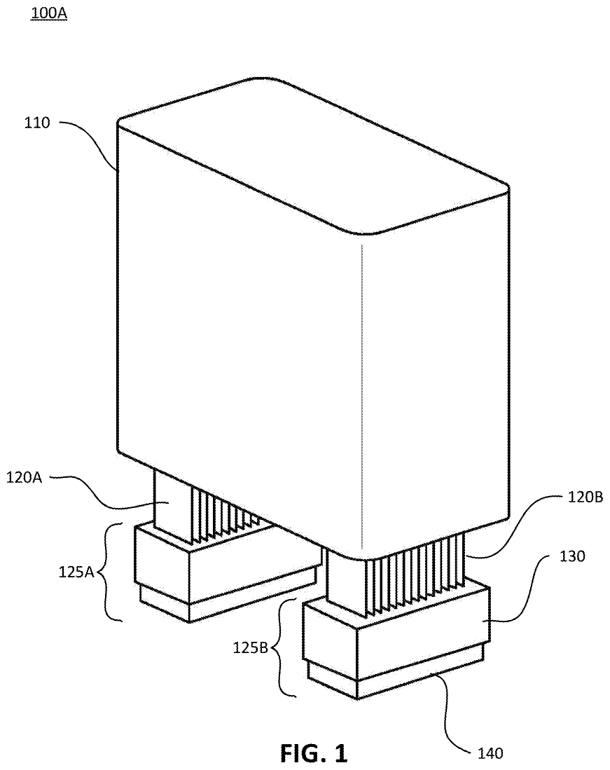

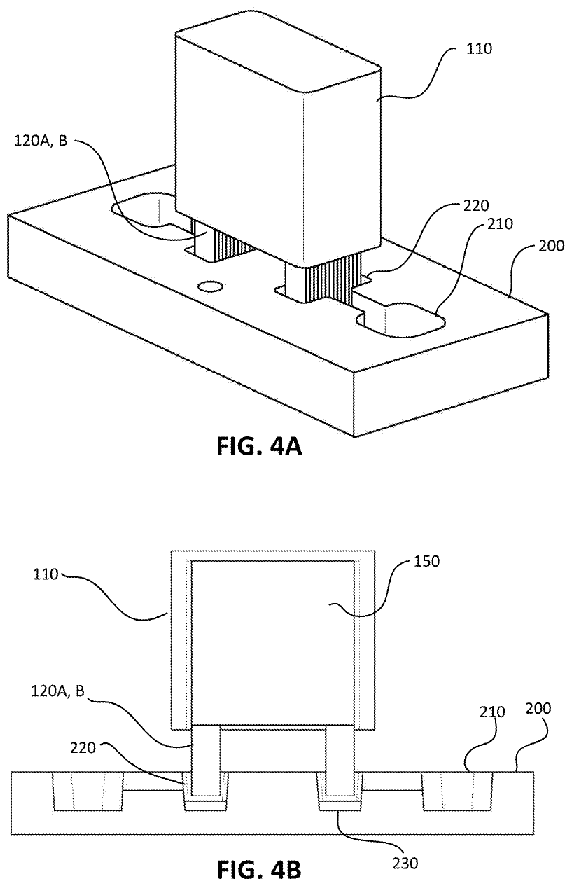

FIG. 1 illustrates a perspective view of a battery 100A with a casted-in-place busbar 125A, B, in accordance with various embodiments of the subject technology. The battery 100A includes an enclosure 110, a battery pack 150 (as shown in FIG. 4B) inserted within the enclosure 110, and a casted-in-place busbars 125A, B. The battery pack 150 includes one or more battery cells. Each battery cell includes a set of electrodes including a plurality of cathode layers and a plurality of anode layers. The plurality of cathode layers includes a plurality of cathode tabs 120A extending therefrom, and the plurality of anode layer includes a plurality of anode tabs 120B extending therefrom. The set of electrodes may be wound or stacked. A spacing between the plurality of cathode layers and a plurality of anode layers of the set of electrodes may be about 1 mm and as low as 250 um.

In one aspect, a first busbar 125A may be formed of a first conductive material 130 that is different from a material of the cathode tabs 120A. In another aspect, a second busbar 125B may be formed of the first conductive material 130 that is different from a material of the anode tabs 120B. In another aspect, the first busbar 125A and the second busbar 125B may each also include second conductive material 140 that is disposed on the first conductive material 130. The first conductive material 130 of the first busbar 125A is in direct contact with the cathode tabs 120A. The first conductive material 130 of the second busbar 125B is in direct contact with the anode tabs 120B.

In some aspects, the busbars 125A, B provide intra-cell electrical connections of tabs 120A, B of a particular battery cell and may also provide inter-cell electrical connections between tabs 120A, B of different battery cells. Depending on battery chemistry, the material of the plurality of cathode tabs 120A and the material of the plurality of anode tabs 120B may be formed of different materials. For example, the plurality of cathode tabs 120A may be formed of aluminum (Al), nickel (Ni) or a nickel plated material. The plurality of anode tabs 120B may be formed of copper (Cu), tin (Sn) coated copper (Cu), or a tin coated material.

The first conductive material 130 may comprise a solder or alloy, such as an aluminum (Al), tin (Sn), or zinc (Zn) alloy having a high electrical conductance and low contact resistance to the tabs 120A, B. The first conductive material 130 may comprise an electrical conductive material having a low melting point that may be easily wetted to the plurality of cathode and anode tabs, 120A and 120B respectively.

The second conductive material 140 may comprise aluminum (Al), copper (Cu), or any other high conductivity metal that may be easily wetted by solder. In one aspect, the second conductive material 140 has an electrical resistance that is less than an electrical resistance of the first conductive material 130. In other aspects, the second conductive material 140 may have a higher electrical conductivity than an electrical conductivity of the first conductive material 130.

The first conductive material 130 may extend between the plurality of tabs 120A, B and the second conductive material 140. In other words, the first conductive material 130 may interconnect the plurality of tabs 120A, B with the second conductive material 140. The second conductive material 140 is configured to provide an area for electrically connecting a corresponding battery cell to other battery cells, a terminal, a battery management module, or an external device. In one aspect, the second conductive material 140 may be disposed on an outer surface of the first and second busbars 125A, B and may extend along one or more outer surfaces of the first and second busbars 125A, B (e.g., a surface and sidewalls) to facilitate connections to other battery cells, a terminal, a battery management unit, or an external device.

Upon casting, the busbars 125A, B form electrical connections for the battery 100A at once, in a single operation, thereby saving time and simplifying construction of the battery 100A over conventional batteries which may utilize separate crimping or welding operations to make such connections.

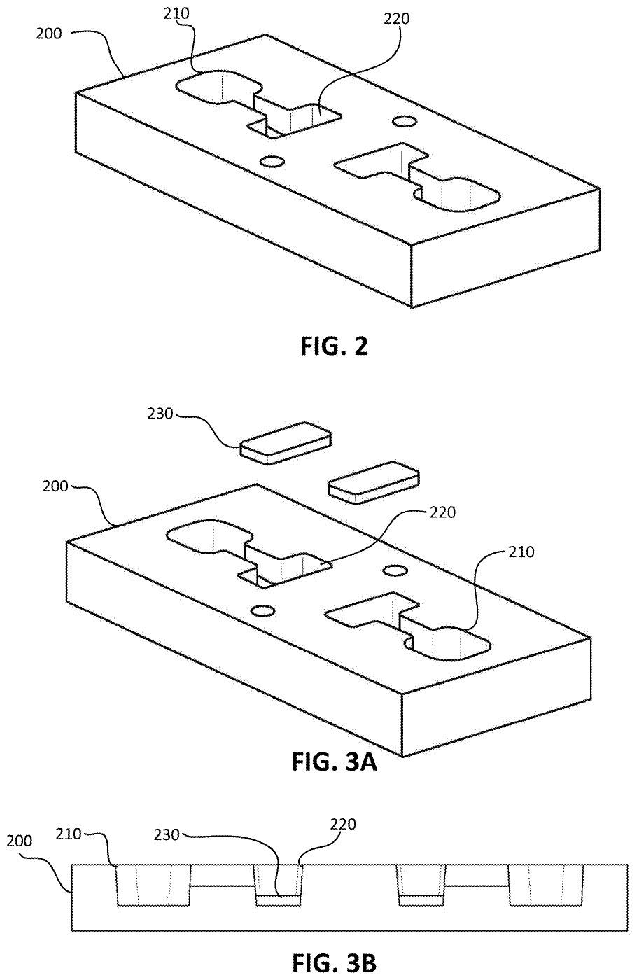

FIG. 2 illustrates a perspective view of a mold 200 used to create a cast-in-place busbar, in accordance with various embodiments of the subject technology. As discussed further below, the mold 200 is utilized to form a busbar. The mold 200 includes a fill port 210 and fill cavity 220. The fill port 210 is in fluid communication with the fill cavity 220. The fill port 210 is configured to receive a molten metal (e.g., solder) and direct the molten metal toward the fill cavity to form a casting.

FIGS. 3A and 3B illustrate views of a mold 200 and inserts 230 used to create a cast-in-place busbar, in accordance with various embodiments of the subject technology. To form the busbars of the subject technology, an insert 230 formed of the second conductive material 140 may be inserted within the fill cavities 220. Specifically, the inserts 230 are disposed on a bottom surface of the fill cavities 220. The inserts 230 may be machined, stamped, casted or formed using other methods as would be known by a person of ordinary skill in the art.

FIGS. 4A and 4B illustrate views of a battery pack 150 inserted within a mold 200 used to create a cast-in-place busbar, in accordance with various embodiments of the subject technology. Tabs 120A, B extending from the battery pack 150 are inserted within the fill cavity 220 of the mold 200 and if utilized, disposed above the inserts 230. The tabs 120A, B are positioned within the fill cavity 220 such that they are in fluid communication with the fill port 210.

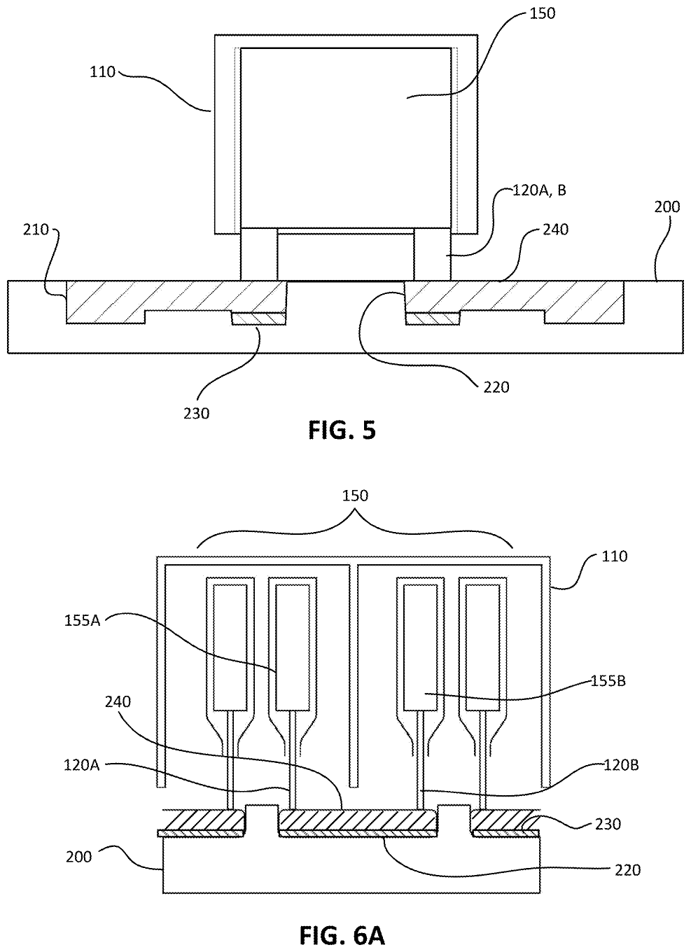

FIG. 5 illustrates a section view of a battery pack 150 inserted within a mold 200 and molten material 240 to form a cast-in-place busbar, in accordance with various embodiments of the subject technology. A molten material 240 (e.g., molten solder) comprising the first conductive material 130 is poured into the fill port 210 and flows into the fill cavity 220 to directly contact and surround the cathode tabs 120A or the anode tabs 120B. The molten material 240 also contacts a surface of the inserts 230 to thereby form a casting connecting the cathode tabs 120A or anode tabs 120B with the corresponding inserts 230 in a single operation.

In one aspect, the molten material 240 comprising the first conductive material 130 is casted or bonded onto the insert 230 comprising the second conductive material 140 at the same time the first conductive material 130 is casted or bonded onto the cathode tabs 120A or the anode tabs 120B.

Upon solidifying of the molten material 240, the battery pack 150 may be removed from the mold 200 by releasing the casting from the mold 200. Excess material may then be removed as necessary revealing a casted-in-place busbar 125A, B comprising the first conductive material 130 and the second conductive material 140 as shown in FIG. 1. Referring to FIG. 1, the first busbar 125A electrically connects the plurality of cathode tabs 120A together and the second busbar 125B electrically connects the plurality of anode tabs 120B together.

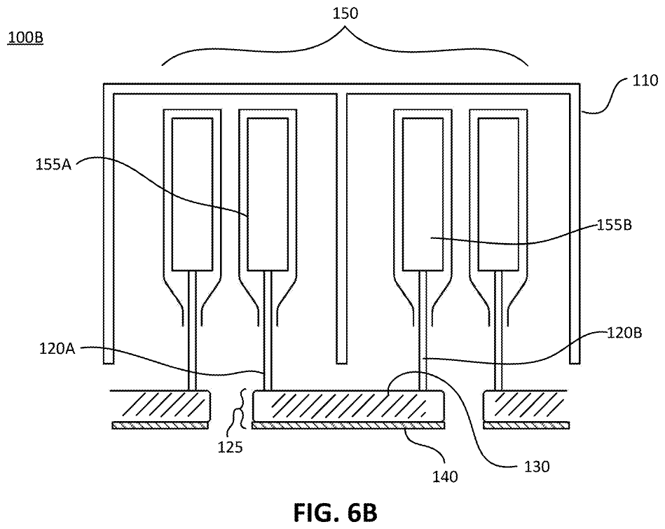

FIG. 6A illustrates an alternative section view of a battery pack 150 inserted within a mold 200 and molten material 240 to form a cast-in-place busbar, in accordance with various embodiments of the subject technology. In one aspect, the battery pack 150 may include a first battery cell 155A and a second battery cell 155B. Tabs 120A, B extending from the first and second battery cells 155A, B, respectively, are disposed within the fill cavity 220 of the mold 200. Molten material 240 is poured into the fill port to thereby cause the molten material 240 to surround the tabs 120A, B of the first and second battery cells 155A, B, respectively. The molten material 240 may comprise a material that is different from a material of the cathode tabs 120A or a material of the anode tabs 120B. If an insert 230 is utilized, the molten material 240 also contacts the insert 230, to thereby form a cast-in-place busbar formed of the first conductive material 130 and the second conductive material 140 (as shown in FIG. 6B).

FIG. 6B illustrates a battery 100B with casted-in-place busbars 125, in accordance with various embodiments of the subject technology. The busbar 125 may be formed of the first conductive material 130 and the second conductive material 140. In one aspect, the busbar 125 electrically connects the plurality of cathode tabs 120A of the first battery cell 155A with the plurality of anode tabs 120B of the second battery cell 155B.

In other aspects, the busbar 125 facilitates a connection to a battery management circuit module that is configured to manage discharging, recharging, and cell balancing of the battery 100A, B. The management circuit module would be coupled to casted-in-place busbar 125 to sense battery cell 155A, B voltages. The battery management circuit module may comprise an integrated circuit having cutoff field-effect transmitters (FETs), fuel-gauge monitor, cell-voltage monitor, cell-voltage balance, real-time clock, and/or a temperature monitor. The battery management module may be connected to casted-in-place busbar 125 by a welding operation, use of a pogo-pin or other spring contact mechanism, or use of a fastener such as a rivet or bolt.

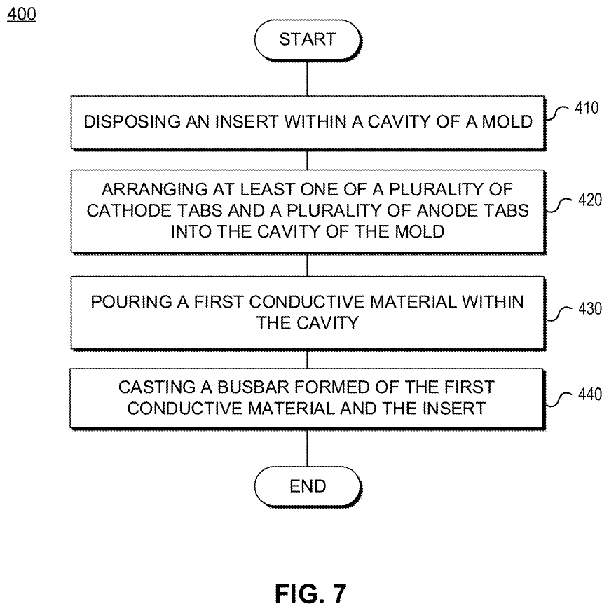

FIG. 7 illustrates an example method 400 for connecting a plurality of tabs of a set of electrodes, in accordance with various embodiments of the subject technology. It should be understood that, for any process discussed herein, there can be additional, fewer, or alternative steps performed in similar or alternative orders, or in parallel, within the scope of the various embodiments unless otherwise stated.

At operation 410, an insert is disposed within a cavity of a mold. At operation 420, at least one of a plurality of cathode tabs extending from a plurality of cathode layers of a first set of electrodes and a plurality of anode tabs extending from a plurality of anode layers of the first set of electrodes are arranged into the cavity of the mold. A spacing between the plurality of cathode layers and a plurality of anode layers of the first set of electrodes may be about 1 mm. At operation 430, a first conductive material is poured within the cavity. The first conductive material comes in direct contact with at least one of the plurality of cathode tabs and the plurality of anode tabs. The first conductive material may comprise a solder or alloy, such as an aluminum (Al), tin (Sn), or zinc (Zn) alloy having a high electrical conductance and low contact resistance to the plurality of cathode and anode tabs. The first conductive material may also comprise an electrical conductive material having a low melting point that may be easily wetted to the plurality of cathode and anode tabs.

At operation 440, a busbar formed of the first conductive material and the insert is casted. The insert comprises a second conductive material and has an electrical resistance that is less than an electrical resistance of the first conductive material. The second conductive material may comprise aluminum (Al), copper (Cu), or any other high conductivity metal that may be easily wetted by solder. In one aspect, the second conductive material has an electrical resistance that is less than an electrical resistance of the first conductive material. In other aspects, the second conductive material may have a higher electrical conductivity than an electrical conductivity of the first conductive material.

In one aspect, the first conductive material is casted onto the insert at the same time the first conductive material is casted onto the at least one of the plurality of cathode tabs and the plurality of anode tabs. In other aspects, the busbar electrically connects the plurality of cathode tabs of the first set of electrodes together. In other aspects, the busbar electrically connects the plurality of anode tabs of the first set of electrodes together.

The method 400 may further include arranging at least one of a plurality of cathode tabs extending from a plurality of cathode layers of a second set of electrodes and a plurality of anode tabs extending from a plurality of anode layers of the second set of electrodes into the cavity of the mold. The busbar may electrically connect the plurality of cathode tabs of the first set of electrodes with the plurality of anode tabs of the second set of electrodes.

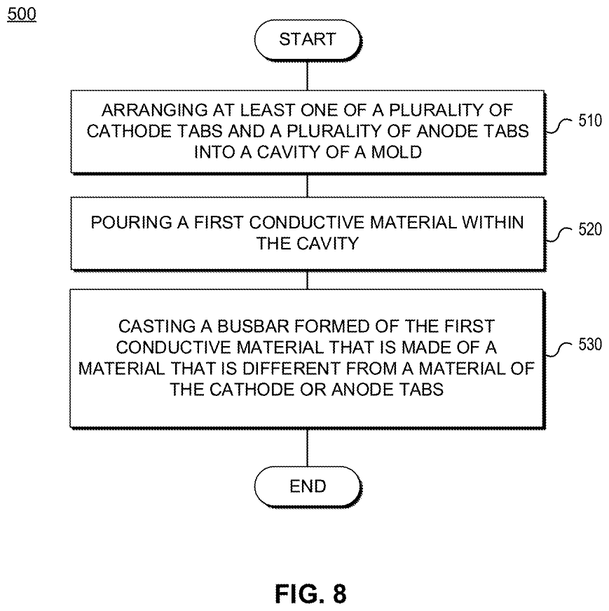

FIG. 8 illustrates an example method 500 for connecting a plurality of tabs of a set of electrodes, in accordance with various embodiments of the subject technology. It should be understood that, for any process discussed herein, there can be additional, fewer, or alternative steps performed in similar or alternative orders, or in parallel, within the scope of the various embodiments unless otherwise stated.

At operation 510, at least one of a plurality of cathode tabs extending from a plurality of cathode layers of a first set of electrodes and a plurality of anode tabs extending from a plurality of anode layers of the first set of electrodes are arranged into a cavity of a mold. At operation 520, a first conductive material is poured within the cavity. The first conductive material comes in direct contact with at least one of the plurality of cathode tabs and the plurality of anode tabs. At operation 530, a busbar formed of the first conductive material is casted. The busbar may electrically connect the plurality of cathode tabs of the first set of electrodes together or the plurality of anode tabs of the first set of electrodes together.

Depending on battery chemistry, the material of the plurality of cathode tabs and the material of the plurality of anode tabs may be formed of different materials. For example, the plurality of cathode tabs may be formed of aluminum (Al), nickel (Ni) or a nickel plated material. The plurality of anode tabs may be formed of copper (Cu), tin (Sn) coated copper (Cu), or a tin coated material. The first conductive material may comprise a solder or alloy, such as an aluminum (Al), tin (Sn), or zinc (Zn) alloy having a high electrical conductance and low contact resistance to the plurality of cathode tabs and the plurality of anode tabs. The first conductive material may also comprise an electrical conductive material having a low melting point that may be easily wetted to the plurality of cathode and anode tabs. The first conductive material may be different from a material of the cathode tabs or a material of the anode tabs.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A battery, comprising:
a first set of electrodes including a plurality of cathode layers and a plurality of anode layers, wherein each cathode layer includes a cathode tab extending therefrom, and wherein each anode layer includes an anode tab extending therefrom; and
a busbar comprising a first conductive material, wherein the first conductive material is in direct contact with at least one of the cathode tabs and the anode tabs;
wherein the first conductive material is different from at least one of a material of the cathode tabs and a material of the anode tabs.

2. The battery of claim 1, further comprising a second conductive material disposed on the first conductive material, wherein the second conductive material has an electrical resistance that is less than an electrical resistance of the first conductive material.

3. The battery of claim 2, wherein the second conductive material comprises aluminum.

4. The battery of claim 2, wherein the first conductive material is casted onto the second conductive material at the same time the first conductive material is casted onto the at least one of the cathode tabs and the anode tabs.

5. The battery of claim 1, wherein the material of the cathode tabs comprise nickel and the material of the anode tabs comprise copper.

6. The battery of claim 1, wherein the first conductive material comprises solder.

7. The battery of claim 1, wherein the first conductive material is cast onto the at least one of the cathode tabs and the anode tabs.

8. The battery of claim 1, wherein the busbar electrically connects the at least one of the cathode tabs and the anode tabs together.

9. The battery of claim 1, further comprising a second set of electrodes including a plurality of cathode layers and a plurality of anode layers, wherein each cathode layer includes a cathode tab extending therefrom, and wherein each anode layer includes an anode tab extending therefrom; and wherein the busbar electrically connects the cathode tabs of the first set of electrodes with the anode tabs of the second set of electrodes.

10. A method for connecting a plurality of tabs of a set of electrodes, the method comprising:
arranging at least one of a plurality of cathode tabs extending from a plurality of cathode layers of a first set of electrodes and a plurality of anode tabs extending from a plurality of anode layers of the first set of electrodes into a cavity of a mold;
pouring a first conductive material within the cavity, wherein the first conductive material comes in direct contact with at least one of the plurality of cathode tabs and the plurality of anode tabs; and
casting a busbar formed of the first conductive material, wherein the first conductive material is different from at least one of a material of the cathode tabs and a material of the anode tabs.

11. The method of claim 10, further comprising disposing an insert within a cavity of a mold.

12. The method of claim 11, wherein the busbar is formed of the of the first conductive material and the insert, wherein the insert comprises a second conductive material having an electrical resistance that is less than an electrical resistance of the first conductive material.

13. The method of claim 12, wherein the second conductive material comprises aluminum.

14. The method of claim 12, wherein the first conductive material is casted onto the insert at the same time the first conductive material is casted onto the at least one of the plurality of cathode tabs and the plurality of anode tabs.

15. The method of claim 10, wherein the material of the plurality of cathode tabs comprises nickel and the material of the plurality of anode tabs comprises copper.

16. The method of claim 10, wherein the first conductive material comprises solder.

17. The method of claim 10, wherein the busbar electrically connects the plurality of cathode tabs of the first set of electrodes together.

18. The method of claim 10, wherein the busbar electrically connects the plurality of anode tabs of the first set of electrodes together.

19. The method of claim 10, further comprising arranging at least one of a plurality of cathode tabs extending from a plurality of cathode layers of a second set of electrodes and a plurality of anode tabs extending from a plurality of anode layers of the second set of electrodes into the cavity of the mold.

20. The method of claim 19, wherein the busbar electrically connects the plurality of cathode tabs of the first set of electrodes with the plurality of anode tabs of the second set of electrodes.
